(19) United States
(12) Patent Application Publication
(10) Pub. No.: US 2010/0056131 A1
(43) Pub. Date: Mar. 4, 2010

(54) METHOD FOR GUARANTEEING AN AVERAGE HSDPA ACCESS BIT RATE IN A CDMA NETWORK

(75) Inventor: Jean-Marc Kelif, Issy Moulineaux (FR)

Correspondence Address: LOWE HAUPTMAN HAM & BERNER, LLP, 1700 DIAGONAL ROAD, SUITE 300, ALEXANDRIA, VA, 22314, US

(73) Assignee: France Telecom, Paris (FR)

(21) Appl. No.: 11/993,057

(22) PCT Filed: Jun. 27, 2006
(86) PCT No.: PCT/FR2006/050642

§ 371 Date: Nov. 16, 2009

(30) Foreign Application Priority Data
Jun. 28, 2005 (FR) 0551788

(51) Int. Cl. H04W 40/00

(52) U.S. Cl. 455/422.1

(57) ABSTRACT

To guarantee an average bit rate and a quality of service, instantaneous bit rates are assigned in a shared HSDPA downlink transport channel requested by a mobile in a CDMA network cell, and a range of signal-to-interference ratios is estimated as a function of a parameter representing the mobile location and the powers received by the mobile to associate therewith a range of instantaneous bit rates admissible in a time interval of the channel. A number of time intervals with instantaneous bit rates selected in the range during a reference period is determined so the average selected instantaneous bit rates over the reference period is substantially equal to the average bit rate. The time intervals are assigned to the mobile if it induces no extra load on the channel over the reference period.

The present invention relates to the assignment of radio resources with high downlink data rates to mobiles in a digital cellular radio communication network.

The invention is more particularly directed to access from mobiles to interactive services at bit rates of several Mbit/s on a shared HSDPA (High Speed Downlink Packet Access) transport channel for a CDMA (Code Division Multiple Access) cellular network of at least the third generation of the UMTS (Universal Mobile Telecommunications System) type.

Telecommunication network operators seek to maximize the number of users that can be served by a CDMA network, in particular by a shared HSDPA downlink transport tunnel, for a given quality of service, which quality of service may vary according to the users.

The shared HSDPA (High Speed Downlink Packet Access) downlink transport channel was developed in order to adapt the radio resource in a more dynamic fashion to the nature of the traffic, consisting of blocks of bits, also known as frames or packets, each included within a time interval with a typical duration of 2 ms, instead of the standard 10 ms. The shared transport channel therefore offers a higher variable transmission bit rate than the WCDMA (Wide Band Code Division Multiple Access) network, and power is allocated to a mobile very quickly.

Dynamic adaptation of the radio resource uses AMC (Adaptive Modulation and Coding) tracking, very fast variations of the radio signal received by a mobile caused by fast fading, and transmitting data via the shared transport channel to a mobile only when the conditions on the radio propagation channel are most favorable and therefore correspond to signal-to-interference ratio peaks.

Known methods of assigning bit rates to mobiles do not take account of the real quality of service (QoS) requirements requested by mobile users and network operators.

Some bit rate assignment methods are based on equitable sharing of radio resources between mobiles present in the cell covered by the base station (Node B) transmitting the shared downlink transport channel. This equitable sharing relates either to the bit rate, which means that each mobile is assigned the same number of time intervals, or to the duration, which means that each of the mobiles is assigned the same bit rate.

In other known bit rate assignment methods, radio resources are assigned to the mobile having the best instantaneous downlink quality, which maximizes the bit rate of the cell. Because of this bit rate assignment criterion, mobiles that are near the base station have a higher probability of being assigned bit rate than other mobiles, and a bit rate can never be assigned to a mobile situated at the limit of the coverage of the cell.

One of the great difficulties in taking the quality of service (QoS) into account, in particular in guaranteeing a mobile a requested bit rate in a shared HSDPA channel, stems from the absence of fast power control. The signal-to-interference ratio (SIR) at which a mobile receives signals cannot be known very accurately at all times and likewise, therefore, the instantaneous bit rate assigned to that mobile.

The object of the invention is to guarantee a quality of service to mobiles according to their real requirements and to optimize the use of the bandwidth associated with the shared transport channel so that the cellular network operator uses the bandwidth that is necessary and sufficient to achieve the required quality of service.

To obtain that object, a method for guaranteeing an average bit rate requested by a mobile for a shared downlink transport channel connection in a cell covered by a given base station in a CDMA type cellular radio communication network, the transport channel sharing out time intervals each assigned to at least one mobile, is characterized in that it includes the following steps:

determining an interference parameter representative of the location of the mobile and of powers received by the mobile,

estimating a range of values of signal-to-interference ratios as a function of the interference parameter in order to associate therewith a range of variation of the instantaneous bit rate admissible in a time interval,

determining a number of time intervals with instantaneous bit rates selected in the instantaneous bit rate variation range during a reference period so that the average of the selected instantaneous bit rates over the reference period is substantially equal to the requested average bit rate, and

assigning the determined number of time intervals to the mobile to admit it with the requested average bit rate if a number of occupied time intervals in the transport channel during the reference period increased by said determined number is less than or equal to a number of time intervals admissible during the reference period.

Briefly, the quality of service guaranteed by the method of the invention consists in assigning the mobile instantaneous bit rates, for example an acceptable maximum instantaneous bit rate in the instantaneous bit rate variation range associated with the interference parameter that has been determined, in available time intervals in determined number during a reference period in order to offer the average bit rate requested by the mobile and to which the user of the mobile has subscribed for a particular service.

The method of the invention is applicable to Real Time (RT) services and Non-Real Time (NRT) services. It is also suitable for choosing strategies for controlling admission of mobiles into a cell and assigning resources favoring bit rates, admission rates, or a compromise between the two, as a function of the requirements of the network operator.

The method of the invention takes account of the real requirements of the operator and the user. It offers a quality of service commensurate with that requested by the user. The user is satisfied because he obtains the requested quality. The operator is satisfied because it optimizes bandwidth use and tends to offer a better quality than that requested.

The average bit rate guarantee method of the invention conforms to:

a load criterion for the admission of a mobile into the network: the load of each base station of the network, in this instance that of the given base station the cell of which the mobile enters, depends on the instantaneous interference and the maximum power of the base station and does not exceed the admissible maximum load, and

an occupancy criterion based on a predetermined number of time intervals admissible during the reference period.

The average bit rate guarantee method of the invention also conforms to a standard power uniformity criterion for the admission of a mobile into the network: the power requested of each of the base stations, including the given base station into the cell of which the mobile enters, does not exceed an admissible maximum power, all the stations being considered as emitting with the same total maximum emit power.

The method of the invention evaluates the load in each cell of the cellular radio communication network by determining the interference parameter:

either as a function of distances between the mobile and the given base station and between the mobile and adjacent base stations deduced from a location of the mobile in the cell covered by the given base station,

or as a function of a measurement of the total power received by the mobile and coming from the base station and the total power received by the mobile and coming from the network.

After determination of the interference parameter, the interference ratio is estimated with great accuracy before the mobile is admitted into the cell. There are defined and stored beforehand correspondences of interference parameter values respectively to pairs of signal-to-interference ratio range limits and pairs of instantaneous bit rate range limits, and associations of signal-to-interference ratios to instantaneous bit rates.

The invention also concerns a system for guaranteeing an average bit rate requested by a mobile for a shared downlink transport channel connection in a cell covered by a given base station in a CDMA type cellular radio communication network, the transport channel sharing out time intervals each assigned to at least one mobile. The system is characterized in that it includes:

means for determining an interference parameter representative of the location of the mobile and of powers received by the mobile,

means for estimating a range of values of signal-to-interference ratios as a function of the interference parameter in order to associate therewith a range of variation of the instantaneous bit rate admissible in a time interval,

means for determining a number of time intervals with instantaneous bit rates selected in the instantaneous bit rate variation range during a reference period so that the average of the selected instantaneous bit rates over the reference period is substantially equal to the required average bit rate, and

means for assigning the determined number of time intervals to the mobile to admit it with the requested average bit rate if a number of occupied time intervals in the transport channel during the reference period increased by said number is less than or equal to a number of time intervals admissible during the reference period.

The above means are distributed in the UTRAN (Universal Terrestrial Radio Access Network) of the CDMA cellular network and are preferably at least partially included in a cellular network RNC (Radio Network Controller).

Other features and advantages of the present invention will become more clearly apparent on reading the following description of preferred embodiments of the invention, given by way of nonlimiting example, with reference to the corresponding appended drawings, in which:

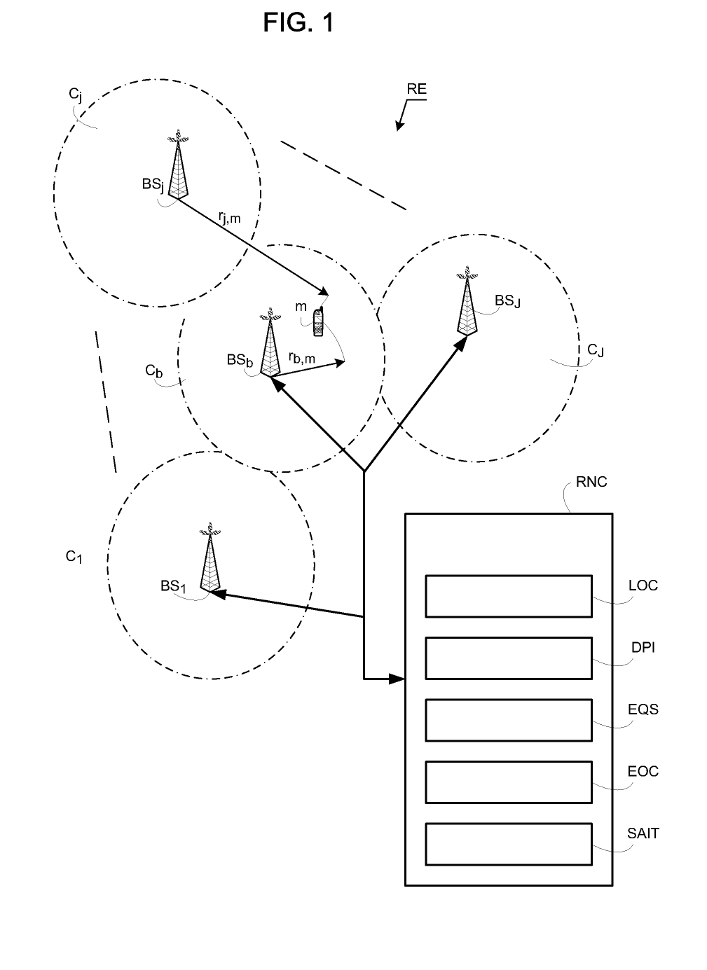

FIG. 1 shows diagrammatically a cellular radio communication network with a radio network controller according to the invention;

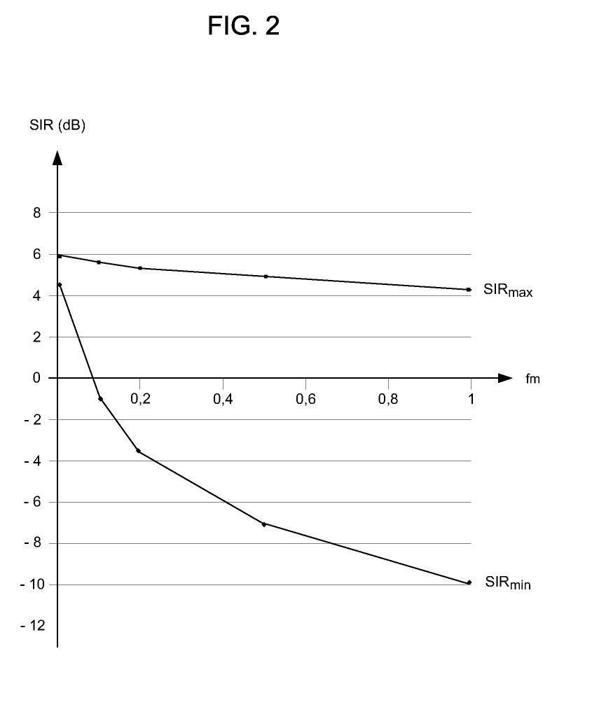

FIG. 2 is a graph showing the signal-to-interference ratio variations as a function of an interference parameter in accordance with the method of the invention; and

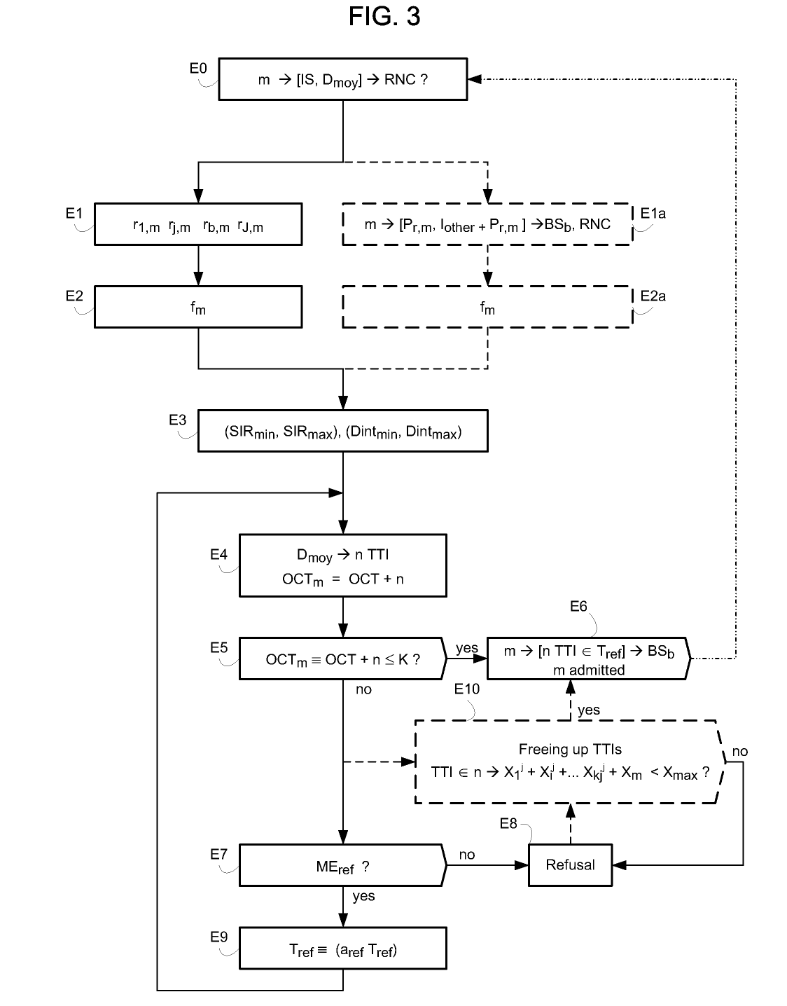

FIG. 3 is a flow chart of the bit rate guarantee method of the invention.

Referring to FIG. 1, a CDMA digital cellular radio communication network RE comprises J base stations BS₁ to BS_{J}, a base station being also called a Node B. A mobile m is situated in the coverage of a given base station BS_{b} of the network, where 1≦b≦J. Hereinafter, the base stations BS₁ to BS_{J} are considered to be adjacent to the given base station BS_{b}, i.e. as being able to interfere with reception by the mobile m when it is communicating with the given base station BS_{b}.

It is assumed that the mobile m communicates with the base station BS_{b} via an HSPDA downlink transport channel including in particular an HS-DSCH (High-Speed Downlink Shared Channel) shared dynamically with other mobiles situated in the cell C_{b} covered by the base station BS_{b}. The HSPDA transport channel also includes other transport channels that are common to the mobiles sharing the HS-DSCH channel. The HSPDA transport channel is divided into TTI (Transmission Time Intervals) of constant duration T_{TTI}, typically 2 ms, and some of them are assigned a priori and irregularly to the mobile m. In a first embodiment, each transmission time interval is assigned to only one mobile at a time.

The received SIR (Signal-to-Interference Ratio), i.e. the ratio of the power received in the channel by the receiver of the mobile to the power of interference received by the receiver of the mobile, is given by the equation:

$$\frac{{P}_{r , m}}{α {I}_{own} + {I}_{other} + Noise} = ( \frac{C}{I} ) \qquad ( 1 )$$

In equation (1):

P_{r,m} is the total power received by the mobile m;

I_{own} is the intra-station interference power received by the mobile m and caused by common channels emitted by the station BS_{b} since a time interval is assigned to only one mobile at a time;

Iₒₜₕₑᵣ is the inter-station interference power received by the mobile m and caused by the base stations BS₁ to BS_{J} other than the given base station BS_{b};

α is an orthogonality factor between 1 and 0; α is equal to 1 if there is no orthogonality between the codes of the downlink channels from the same base BS_{b} and equal to 0 if their orthogonality is perfect; and

Noise is the thermal noise power of the receiver of the mobile.

In a propagation model with fast fading and effect of shadowing, the powers P_{r,m}, I_{own} and Iₒₜₕₑᵣ depend on attenuation coefficients g_{1,m} to g_{J,m}. Each attenuation coefficient g_{j,m} is representative of the attenuation between 0 and 1, equal to the ratio of the power received by the receiver of the mobile m to the power emitted in the shared downlink channel from the respective base station BSⱼ to the mobile m, the index j being such as 1≦j≦J. The attenuation coefficient g_{j,m} depends on

the product of the attenuation r_{j,m}^{η} according to the distance r_{j,m} from the base station BSⱼ to the mobile m, where η is a propagation coefficient typically lying between −3 and approximately −4,

fast fading of the power emitted by the base station BSⱼ and represented by a fast fading factor Φ_{J} less than 1, and

an effect of shadowing of the power emitted by the base station BSⱼ and represented by a shadowing factor 10^{ζ}^{ⱼ}^{/10} that depends on a normal variable ζⱼ and that is a log-normal random variable, the standard deviation whereof is typically of the order of 6 dB to 12 dB.

The powers P_{r,m}, I_{own} and Iₒₜₕₑᵣ in equation (1) are then written:

$${P}_{r , m} = K ( {P}_{b} - {P}_{CC} ) {r}_{b , m}^{η} {10}^{{ζ}_{b} / 10} {φ}_{b}$$

$${I}_{own} = {KP}_{CC} {r}_{b , m}^{η} {10}^{{ζ}_{b} / 10} {φ}_{b}$$

$${I}_{other} = {\sum }_{{j \neq b}^{j = 1}}^{j = J} {KP}_{j} {r}_{j , m}^{η} {10}^{{ζ}_{j} / 10} {φ}_{b} .$$

In the above equations, P_{b} is the total power of the base station BS_{b}, P_{CC} is the emit power of the common transport channels associated with the HS-DSCH transport channel on the downlink channel from the base station BS_{b}, and Kr_{b,m}^{η} represents the loss of power caused by propagation, which is a function of the distance between the given base station BS_{b} and the mobile m.

In accordance with the object of the invention, a good quality of service QoS is obtained by good transmission between the given base station BS_{b} and the mobile m, and therefore with a good signal-to-interference ratio SIR, using the maximum emit power of the base stations BS₁ to BSⱼ. It is then considered that all stations emit with the same total maximum emit power, that is to say P_{b}=Pⱼ with 1≦j≦J.

The power P_{CC} dedicated to emitting on the common transport channels is a fraction φ of the total emit power of the base station BS_{b}, i.e. P_{CC}=φP_{b}.

In expressing the powers, equation (1) then becomes:

$$\frac{{P}_{b} ( 1 - ϕ ) {r}_{b , m}^{η} {10}^{{ζ}_{b} / 10} {φ}_{b}}{αϕ {P}_{b} {r}_{b , m}^{η} {10}^{{ζ}_{b} / 10} {φ}_{b} + {P}_{b} {\sum }_{{j \neq b}^{j = 1 ,}}^{j = J} {r}_{j , m}^{η} {10}^{{ζ}_{j} / 10} {φ}_{j} + Noise} = ( \frac{C}{I} ) \qquad ( 2 )$$

In equation (2), the orthogonality factor α is not negligible because of the orthogonality error and therefore the misalignment of the codes in the downlink channels caused by the multiple paths in the downlink channel. In practice, the thermal noise power of the mobile receiver is low compared to the power P_{r,m} received by the mobile, which is expressed as follows:

$$\frac{Noise}{{P}_{b} {r}_{b , m}^{η} {10}^{{ζ}_{b} / 10} {φ}_{b}} << αϕ + \frac{1}{{r}^{η} {φ}_{b}} {\sum }_{{j \neq b}^{j = 1 ,}}^{j = J} {r}_{j , m}^{η} {10}^{( {ζ}_{j} - {ζ}_{b} ) / 10} {φ}_{j}$$

The equation (2) becomes:

$$\frac{( 1 - ϕ )}{αϕ + \frac{1}{{r}_{b , m}^{η} {φ}_{b}} {\sum }_{{j \neq b}^{j = 1 ,}}^{j = J} {r}_{j , m}^{η} {10}^{( {ζ}_{j} - {ζ}_{b} ) / 10} {φ}_{j}} ≅ ( \frac{C}{I} ) \qquad ( 3 )$$

In this equation, the interference power Iₒₜₕₑᵣ and consequently the fast fading caused by the emissions from the other base stations BSⱼ, where j≠b, dominate the signal-to-interference ratio SIR received by the mobile, which limits the capacity of the network. Fast fading is a complex phenomenon that the invention analyzes by a probability approach.

For the mobile m in the network RE, an interference parameter fₘ is defined as the ratio of the interference power Iₒₜₕₑᵣreceived by the mobile m from other stations to the power received from the respective base station BSb on the assumption that the fast fading from the base stations is of the same order of magnitude, and likewise the shadowing, to a lesser degree:

$${f}_{m} = \frac{1}{{r}_{bm}^{η}} {\sum }_{{j \neq b}^{j = 1 ,}}^{j = J} {r}_{j , m}^{η} ≅ \frac{{I}_{other}}{{P}_{r , m}} \qquad ( 4 )$$

The interference parameter is therefore representative of the location of the mobile and the powers received by the mobile.

As shown in FIG. 2, for a given value of the interference parameter fₘ that is determined as a function of the position of the mobile m in the network RE that is defined by the distances r_{1,m} to r_{J,m} between the base stations and the mobile m, the signal-to-interference ratio SIR received in accordance with equation (3) has a probability of about 90% of being between a maximum ratio SIRₘₐₓ and a minimum ratio SIRₘᵢₙ.

Starting with a graph like that in FIG. 2, a controller connected to the given base station BS_{b}, or possibly partially incorporated therein, estimates as a function of the interference parameter fm the signal-to-interference ratio SIR received that the mobile could admit and therefore the instantaneous bit rate that it could require. Consequently, the control means are able to admit or to refuse “entry” of the mobile into the cell C_{b} in order for the mobile to communicate with the base station BS_{b} via the shared HS-DSCH channel if at least one average bit rate required by the mobile is reached as an indicator of quality of service, or to refuse entry of the mobile if the network is incapable of offering it the required quality of service and thus if the network offers it a bit rate lower than the average bit rate required following too low a signal-to-interference ratio SIR received by the mobile. If the service is of the real time type, for example a “streaming” multimedia service offering a continuous stream of content to be listened to and/or viewed, the controller also aims to offer a substantially regular bit rate over a predetermined time.

The average bit rate guarantee method of the invention is preferably implemented in a radio network controller RNC of the fixed system of the cellular network RE. The controller RNC controls the radio load so as to distribute radio resources to one or more base stations (Nodes B), in this instance the given base station BS_{b} in particular, as shown in FIG. 1, and the admission of mobiles into the cells of the base stations that the controller RNC manages.

Alternatively, the method of the invention is implemented in the given base station BS_{b}, constituting a Node B to use the terminology of the Universal Terrestrial Radio Access Network (UTRAN). The Node B is responsible in particular for radio transmission and reception between the network RE and mobiles situated in the cell C_{b} covered by the Node B. In particular, the invention makes use of functions of the Node B, such as bit rate adaptation and mutual checks on the emit powers of the node and the mobiles.

Another alternative is for the method of the invention to be implemented partly in the given base station BS_{b} (Node B) and partly in the controller RNC.

In the remainder of the description, the average bit rate guarantee method is assumed to be executed essentially in the controller RNC via the given base station BS_{b}. As shown diagrammatically in FIG. 1, the controller RNC comprises, in relation to the invention, a localization module LOC, an interference parameter determination module DPI, a quality of service estimator EQS, an occupancy estimator EOC, and a time interval assignment server SAIT.

The location module LOC locates the mobiles in the cells monitored by the controller RNC. For example, a mobile m in the cell C_{b} is located by measuring the round trip time of a predetermined signal between each of three adjacent base stations, including the station BS_{b} covering the cell C_{b}. The location module LOC estimates the geographical coordinates of the mobile by triangulation from the three base stations.

The interference parameter determination module DPI contains a prestored program conforming to equation (4) in order to determine an interference parameter fₘ as a function of measured distances or powers, representing the extra load of the mobile m entering the cell C_{b} of the base station BS_{b}, whilst conforming to the base station load criterion.

The quality of service estimator EQS holds a prestored graph G(SIR(fₘ)) analogous to that of FIG. 2 in the form of a table establishing correspondences between discrete values of the interference parameter fₘ and respective pairs of limits (SIRₘᵢₙ, SIRₘₐₓ) of signal-to-interference ratio ranges and pairs (Dinstₘᵢₙ, Dinstₘₐₓ) of instantaneous bit rate range limits. The estimator also holds a prestored table of associations between respective signal-to-interference ratios SIR and instantaneous bit rates Dinst.

The occupancy estimator EOC decides to admit or to refuse a mobile to be connected via a downlink shared transport channel HS-DSCH as a function of an average bit rate requested by the mobile.

The time interval assignment server SAIT periodically assigns time intervals available in the downlink shared transport channel HS-DSCH of the cell C_{b} to mobiles that have requested admissible average service bit rates.

As shown in FIG. 3, the average bit rate guarantee method of the invention comprises steps E1 to E9.

Initially, in the step E0, the mobile m is on standby, is situated in the coverage of the cell C_{b} and decides to transmit a connection request to the radio network controller RNC via a base station, for example the station BS_{b}, controlled by the controller RNC. The request indicates that an HSPDA transport channel connection is required and includes a service identifier IS including a requested average bit rate D_{moy}. The average bit rate D_{avg} is requested by the mobile for a reference period T_{ref}=N×T_{TTI} during which a predetermined number N of time intervals TTI that may be relatively large, for example equal to 1000, is admissible. N is typically a parameter determined by the operator.

Alternatively, the average bit rate D_{avg} requested is read in a memory of the controller RNC addressed by the service identifier IS.

In the step E1, the location module LOC in the controller RNC locates the mobile m that is seeking to be admitted into the cell C_{b} and supplies the geographical coordinates of the position of the mobile m. The module LOC derives from the geographical coordinates of the mobile m the distance r_{b,m} between the mobile and the given base station BS_{b} and the distances r_{1,m} to r_{J,m} between the mobile and the adjacent stations BS₁ to BS_{J}.

Then, in the step E2, the module DPI determines the interference parameter fₘ as a function of the distances r_{1,m} to r_{J,m} from equation (4).

Alternatively, the position of the mobile m is considered unknown and the location module LOC is eliminated. The steps E1 and E2 are then replaced by steps E1a and E2a, as shown in dashed lines in FIG. 3. In the step E1a, the mobile measures the total power P_{r,m} received by the mobile from the given base station BS_{b} and the total power Iₒₜₕₑᵣ+P_{r,m} received by the mobile from the whole of the network, and transmits those measured powers to the controller RNC via the base station BS_{b}. Then, in the step E2a, the module DPI determines the interference parameter fₘ as a function of the measured power ratio Iₒₜₕₑᵣ/P_{r,m}.

In the step E3 following on from the step E2 or E2a, the quality of service estimator EQS estimates as a function of the prestored graph G(SIR(fₘ)) a range (SIRₘᵢₙ, SIRₘₐₓ) of signal-to-interference ratio values representative of a quality of service QoS for the value of the interference parameter fₘ supplied by the module DPI and depending on the extra load introduced by the mobile m in the base station BS_{b}. As a function of the range (SIRₘᵢₙ, SIRₘₐₓ), the estimator EQS determines an instantaneous bit rate variation range (Dinstₘᵢₙ, Dinstₘₐₓ) admissible in a time interval TTI.

Then, in the step E4, as a function of the instantaneous bit rate range (Dinstₘᵢₙ, Dinstₘₐₓ) supplied by the module EQS, the occupancy estimator EOC estimates a range (nₘᵢₙ, nₘₐₓ) of the numbers of time intervals TTI that are necessary for the mobile to transmit data in the downlink shared transport channel HS-DSCH with the requested average bit rate D_{moy} during the reference period T_{ref}, whilst conforming to the occupancy criterion.

The occupancy estimator EOC preferably maximizes the instantaneous bit rate for all the time intervals liable to be assigned to the mobile m by selecting the maximum instantaneous bit rate Dinstₘₐₓ of the range previously determined in order for transmission of data by the mobile m to occupy only a minimum number nₘᵢₙ of available time intervals during the reference period T_{ref}, whilst maintaining the requested average bit rate D_{moy} on average over the reference period.

However, the instantaneous bit rates Dinstₖ belonging to the range (Dinstₘᵢₙ, Dinstₘₐₓ) that has been determined can be selected by the estimator EOC so that they are a priori different in the available time intervals TTI assigned to the mobile m and chosen, for example, in accordance with criteria for minimizing intersymbol interference between the data in successive time intervals assigned to different mobiles, namely:

$${D}_{moy} = \frac{1}{K} {\sum }_{{j \neq b}^{k = 1 ,}}^{k = K} {Dinst}_{k} ,$$

where Dinstₖ∈(Dinstₘᵢₙ, Dinstₘₐₓ), and Dinstₖ=0 for TTIₖ already occupied by data for a mobile other than the mobile m.

The estimator EOC designates by n∈(nₘᵢₙ, nₘₐₓ) the determined number of time intervals TTI that would be necessary for the mobile m to receive data with the average bit rate during the reference period and therefore with bit rates Dinstₖ≠0, and estimates the total occupancy OCTₘ of the downlink shared transport channel HS-DSCH:

OCTₘ=n+OCT,

where OCT is the number of time intervals TTI already occupied by data in the transport channel during the reference period for other mobiles prior to the connection request, each time interval being shared simultaneously by sequences of codes assigned to a plurality of mobiles.

In the step E5, the occupancy estimator EOC compares the estimated total occupancy OCTₘ to the admissible occupancy of the shared transport channel represented by the number K of time intervals during the reference period T_{ref}.

In a first embodiment, if the estimated occupancy OCTₘ is less than or equal to the admissible occupancy K in the step E5, then, in the step E6, the occupancy estimator EOC commands in the time interval assignment server SAIT in the controller RNC the assignment (scheduling) in real time of n available time intervals TTI that were discounted for the mobile m in the step E4. The server SAIT then manages the radio resource with the admitted mobile m in a manner that is known in the art, first by occupying n time intervals assigned during a reference period T_{ref} in the downlink shared transport channel HS-DSCH in the downlink radio channel from the given base station BS_{b} to the mobile m. The bit rate in the n time intervals assigned is on average equal to the required average bit rate D_{avg} for each reference period.

Then, after the step E6, the method returns to the step E1 or E11 in order to adapt the number n of time intervals TTI assigned to the mobile continuously to the position of the mobile in the cell C_{b} and therefore to the receive signal-to-interference ratio of the mobile during communication with the requested service.

The steps of the method and therefore the determination of the number n of time intervals TTI are executed periodically for each mobile, with an execution period less than the reference period, for example ten times in each reference period.

If the estimated occupancy OCTₘ is greater than the admissible occupancy K in the step E5, the reference period over which the average bit rate D_{moy} offered is saturated. The mobile m cannot be accepted for that reference period. For example, if the reference period is 2000 ms and includes a number K=1000 time intervals TTI, and if five mobiles are respectively occupying 200, 440, 300, 10 and 40 time intervals, that is a total number of occupied time intervals OCT=990, the reference period is almost saturated and admission of the mobile is refused if the determined number n of time intervals TTI to be assigned to the mobile m is greater than K−OCT=10.

The occupancy estimator EOC checks in memory whether the operator of the network RE will accept an error margin ME_{Tref} or jitter over the reference period T_{ref} in the step E7. If no error margin is acceptable, the connection or the continuation of the connection of the mobile m to the network RE via the downlink shared transport channel HS-DSCH is refused by the occupancy estimator EOC in the step E8 and that refusal is signaled to the mobile by the time interval allocation server SAIT.

If not, the occupancy estimator EOC increases the reference period T_{ref} by an amount at most equal to the error margin ME_{Tref}, for example by multiplying the reference period by a factor a_{ref} such that (a_{ref} T_{ref})<ME_{Tref} in the step E9. The factor a_{ref} is typically equal to 2. The parameters T_{ref}, a_{ref}, M_{ref} are typically initialized by the operator.

The method then returns to the step E4 for the occupancy estimator EOC to determine another number n of time intervals TTI that are liable to be available during the new reference period T_{ref}≡(a_{ref} T_{ref}). The determination of the number n conforms to the instantaneous bit rate range (Dinstₘᵢₙ, Dinstₘₐₓ) determined by the module EQS in the step E3 for each time interval available to be assigned to the mobile m during the new reference period so that the required average bit rate D_{moy} requested by the mobile can be guaranteed on average over the new reference period.

One or more increases in the reference period can be attempted progressively until the condition OCT+n≦K is satisfied in a step E6 and n time intervals are therefore assigned (scheduling) to the mobile m in the cell C_{b}. Otherwise the connection with the requested average bit rate D_{moy} is refused to the mobile m in a step E8 if the error ratio ME_{Tref} is reached, i.e. T_{ref}>T_{ref}+ME_{Tref}.

In a second embodiment illustrated diagrammatically in dashed line in FIG. 3, if the estimated occupancy OCTₘ is greater than the admissible occupancy K in the step E5, or if connection of the mobile m to the network is refused in the step E8, then the occupancy estimator EOC executes a step E10 indicated in dashed line in FIG. 3. The occupancy estimator EOC then simulates a reduction of the occupancy caused by other mobiles m_{b} and therefore the number of time intervals occupied by those other mobiles that receive data in time intervals TTI of the downlink shared transport channel HS-DSCH from the base station BS_{b} in the cell C_{b} in order to free up a sufficient number n of time intervals and thereby admit the mobile m in the step E6. Otherwise the mobile m is refused in the step E8.

For the second embodiment, the occupancy estimator EOC first selects mobiles m_{b} with the highest average bit rates and each of which therefore occupies a large number of time intervals during the reference period T_{ref}. Those mobiles can also be those at the greatest distances from the base station BS_{b} in the cell C_{b}.

The occupancy estimator preferably guarantees bit rates in an optimum and fair manner to the requesting mobile m and to the selected mobiles m_{b} currently in communication having the highest average bit rates in the shared transport channel in the cell C_{b} by seeking to maximize the bit rates for those mobiles, for example by maximizing the following function:

$${\sum }_{{m}_{b}} \frac{{Dinst}_{{m}_{b}}^{1 - β}}{1 - β}$$

in which:

Dinst_{mb} designates the instantaneous bit rate of a particular mobile m_{b}, including the mobile m, and

β designates a variable parameter for selection of a bit rate allocation strategy, less than 1.

If the parameter β tends to 1, the assignment of bit rates is proportionately fair, i.e. the number of mobiles admitted with an optimum bit rate is maximized.

The invention has been particularly described hereinabove for non-real time (NRT) services, and therefore services without delay constraints, accessible for mobiles by time intervals of the HSPDA downlink shared channel that have been developed to maximize the benefit best radio link conditions, in order to maximize the efficacy of downlink transmission.

However, as an alternative to this, a real time (RT) multimedia service, such as streaming, which imposes delay constraints, may be requested by a mobile m. In this case, the occupancy estimator EOC selects the n time intervals available to be assigned to the mobile m so that they are substantially regularly distributed through the reference period T_{ref} in order to guarantee a substantially regular bit rate over the reference period that is acceptable for a streaming connection, which provides a high quality of service QoS. For example, the mobile that requires 10 TTI over the reference period of 1000 TTI could be assigned a TTI every 100 TTI in order to offer regular arrival of packets.

In a third embodiment of the invention, access via the HSDPA downlink channel offers the given base station BS_{b} the possibility of transmitting data to a plurality of mobiles at the same time. A plurality of mobiles has bit rates assigned at the same time during a time interval TTI. In this case, the average bit rate guarantee method of the invention is generalized in the following manner, as also shown diagrammatically in the step E10.

The cell C_{b} manages I mobiles m₁ to m_{I} that are divided into P groups G₁, . . . Gₚ, . . . G_{P} respectively comprising k₁ mobiles (m₁¹, m₂¹, . . . mₖ₁¹), . . . kₚ mobiles (m₁^{p}, m₂^{p}, . . . mₖₚ^{p}), . . . k_{P} mobiles (m₁^{P}, m₂^{P}, . . . m_{kP}^{P}) where 1≦p≦P and k_{1+ . . . k}ₚ+ . . . k_{P}=I. The kₚ mobiles (m₁^{p}, m₂^{p}, . . . mₖₚ^{p}) of the group Gₚ are assigned bit rates at the same time during respective time intervals TTI of the reference period T_{ref} so that each mobile of the group receives respective coded data during said respective time intervals.

The average bit rate guarantee method, first and second embodiments of which are described hereinabove, is equally applicable to each group Gₚ of mobiles simultaneously requiring connections via the HSPDA transport channel, in place of the mobile m.

In the steps E4 and E5, a time interval TTI, for example relating to the group Gₚ, during which data is transmitted to kₚ−1 mobiles by the given base station BS_{b} is considered “free” when it can admit a new mobile. If Xₘₐₓ is the maximum load admissible during a time interval TTI by the cell C_{b}, the new mobile is admitted in the step E6 if, in addition to the condition OCTₘ+n≦k being satisfied, the following condition is satisfied:

$${\sum }_{i = 1}^{i = {k}_{p}} {X}_{i}^{p} < {x}_{max} , \qquad ( 5 )$$

where Xᵢ^{P} is the load induced by the mobile mᵢ^{P} of the group Gₚ in the time interval TTI.

A mobile mₑ requesting admission to the cell C_{b} cannot enter if it induces an extra load Xₘₑ in at least one group. If the condition (5) is not satisfied in said at least one group, the occupancy estimator EOC redistributes the I mobiles in the P groups so that the load is maximized for the greatest number of groups. In most cases the occupancy estimator then obtains at least one group whose load has been reduced, and chooses the group Gₑ with kₑ mobiles having the lowest load, where 1≦e≦P.

If

$${\sum }_{i = 1}^{i = {k}_{e}} {X}_{i}^{e} + {X}_{{m}_{e}} < {x}_{max} ,$$

then the occupancy estimator accepts assignment of an instantaneous bit rate to the mobile me in the time interval TTI associated with the group Gₑ.

In other words, if in each of the n time intervals the mobile also induces an admissible extra load, the number n of time intervals determined is assigned to the mobile. The admission effected in this way for each of the n time intervals of the reference period that can be assigned to the mobile mₑ substantially imposes the requested average bit rate D_{moy} during the reference period.

If the load is already the maximum load for each of the groups G₁ to Gₚ, the connection of the mobile mₑ to the network RE via the shared transport channel is refused by the occupancy estimator EOC in the step E8.

The invention described here relates to a method and a system for guaranteeing an average bit rate in a CDMA cellular network. In a preferred embodiment, the steps of the method are determined by the instructions of a program for guaranteeing an average bit rate requested by a mobile m for a downlink shared transport channel connection in a cell C_{b} covered by a given base station BS_{b} in a cellular radio communication network RE of the CDMA type. The program is loaded into an average bit rate guarantee system whose operation is then controlled by the execution of the program and which can, for example, be partially or entirely included in the controller RNC of the cellular network RE. When the program is loaded into and executed in the system for guaranteeing an average bit rate in the network, the instructions of the program execute the steps of the method according to the invention.

Consequently, the invention applies equally to a computer program, in particular a computer program on or in an information medium, adapted to implement the invention. That program can use any programming language, and be in the form of source code, object code or an intermediate code between source code and object code, such as in a partially compiled form, or in any other form desirable for implementing the method according to the invention.

The information medium can be any entity or device capable of storing the program. For example, the support can include storage means, such as a ROM, for example a CD-ROM or a microelectronic circuit ROM, or a USB key, or magnetic storage means, for example a diskette (floppy disk) or a hard disk.

Moreover, the information medium can be a transmissible medium such as an electrical or optical signal, which can be routed via an electrical or optical cable, by radio or by other means. The program according to the invention can in particular be downloaded over an Internet type network.

Alternatively, the information medium can be an integrated circuit in which the program is incorporated, the circuit being adapted to execute or to be used in the execution of the method according to the invention.

1. A method of guaranteeing an average bit rate requested by a mobile for a shared downlink transport channel connection in a cell covered by a given base station in a CDMA type cellular radio communication network, said transport channel sharing out time intervals each assigned to at least one mobile, said method including:
determining an interference parameter representative of the location of said mobile and of powers received by said mobile,
estimating a range of values of signal-to-interference ratios as a function of said interference parameter in order to associate therewith a range of variation of the instantaneous bit rate admissible in a time interval,
determining a number of time intervals with instantaneous bit rates selected in said instantaneous bit rate variation range during a reference period so that the average of the selected instantaneous bit rates over said reference period is substantially equal to the requested average bit rate, and
assigning the determined number of time intervals to said mobile to admit it with the requested average bit rate if a number of occupied time intervals in said transport channel during said reference period increased by said determined number is less than or equal to a number of time intervals admissible during said reference period.

2. A method as claimed in claim 1, further including locating said mobile in said cell so as to derive the distance between said mobile and said given base station and between said mobile and the adjacent stations, the interference parameter being determined as a function of the distances.

3. A method as claimed in claim 2, wherein the interference parameter is determined in accordance with the formula:
$$\frac{1}{{r}_{bm}^{η}} {\sum }_{{j \neq b}^{j = 1 ,}}^{j = J} {r}_{j , m}^{η}$$
where r_{b,m} is the distance between said given base station and said mobile, r_{j,m} is the distance between a base station other than said given base station and said mobile, η is a propagation coefficient lying between −3 and approximately −4, and J is the number of base stations.

4. A method as claimed in claim 1, including measuring the total power received by said mobile from said given base station and the total power received by the mobile from the network, the interference parameter being determined as a function of the measured powers.

5. A method as claimed in claim 1, wherein the selected instantaneous bit rates are a maximum instantaneous bit rate in said instantaneous bit rate variation range associated with the determined interference parameter.

6. A method as claimed in claim 1, including storing beforehand correspondences of interference parameter values respectively to pairs of signal-to-interference ratio range limits and pairs of instantaneous bit rate range limits, and associations of signal-to-interference ratios to instantaneous bit rates.

7. A method as claimed in claim 1, including increasing said reference period if the number of occupied time intervals increased by said determined number of time intervals is more than the number of admissible time intervals so as to return to the determining step a[???] to determine another number of time intervals.

8. A method as claimed in claim 1, including reducing the number of occupied time intervals by other mobiles that transmit data with highest average bit rates in time intervals of said downlink shared transport channel in order to free up a sufficient number of time intervals if the number of occupied time intervals of said transport channel increased by said determined number of time intervals is more than the number of admissible time intervals.

9. A method as claimed in claim 1, wherein said steps are executed with an execution period less than said reference period.

10. A method as claimed in claim 1, wherein plurality of mobiles have bit rates assigned at the same time during a time interval, and the number of determined time intervals is assigned to said mobile if furthermore in each of the time intervals the mobile induces an admissible extra load.

11. A method as claimed in claim 1, wherein the time intervals assigned to said mobile are substantially regularly distributed through said reference period.

12. A system for guaranteeing an average bit rate requested by a mobile for a shared downlink transport channel connection in a cell covered by a given base station in a CDMA type cellular radio communication network, said transport channel sharing out time intervals each assigned to at least one mobile, said system including:
means for determining an interference parameter representative of the location of said mobile and of powers received by said mobile,
means for estimating a range of values of signal-to-interference ratios as a function of said interference parameter in order to associate therewith a range of variation of the instantaneous bit rate admissible in a time interval,
means for determining a number of time intervals with instantaneous bit rates selected in said instantaneous bit rate variation range during a reference period so that the average of the selected instantaneous bit rates over said reference period is substantially equal to the required average bit rate, and
means for assigning the determined number of time intervals to said mobile to admit it with the requested average bit rate if a number of occupied time intervals in said transport channel during said reference period increased by said number is less than or equal to a number of time intervals admissible during said reference period.

13. A system as claimed in claim 12, wherein said means are at least partially included in a controller of said cellular network.

14. A computer arrangement performed in a control arrangement of a CDMA type cellular radio communication network, said computer arrangement being adapted to guarantee an average bit rate requested by a mobile for a shared downlink transport channel connection in a cell covered by a given base station in said CDMA network, said transport channel sharing out time intervals each assigned to at least one mobile,
said computer arrangement being arranged for executing the following steps:
determining an interference parameter representative of the location of said mobile and of powers received by said mobile,
estimating a range of values of signal-to-interference ratios as a function of said interference parameter in order to associate therewith a range of variation of the instantaneous bit rate admissible in a time interval,
determining a number of time intervals with instantaneous bit rates selected in said instantaneous bit rate variation range during a reference period so that the average of the selected instantaneous bit rates over said reference period is substantially equal to the requested average bit rate, and
assigning the determined number of time intervals to said mobile to admit it with the requested average bit rate if a number of occupied time intervals in said transport channel during said reference period increased by said determined number is less than or equal (E5) to a number of time intervals admissible during said reference period.

15. A computer readable information medium for the computer arrangement claimed in claim 14 and adapted to guarantee an average bit rate requested by a mobile for a shared downlink transport channel connection in a cell covered by a given base station in a CDMA type cellular radio communication network, the transport channel sharing out time intervals each assigned to at least one mobile.
